(19) United States
(12) Patent Application Publication
(10) Pub. No.: US 2005/0144409 A1
(43) Pub. Date: Jun. 30, 2005

(54) Data processing device and method utilizing latency difference between memory blocks

(75) Inventors: Akira Nodomi, Kawasaki (JP); Tatsumi Nakada, Kawasaki (JP); Eiki Ito, Kawasaki (JP); Hideki Sakata, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/059,472

(22) Filed: Feb. 16, 2005

Related U.S. Application Data
(63) Continuation of application No. PCT/JP02/09290, filed on Sep. 11, 2002.

(51) Int. Cl. G06F 12/00

(52) U.S. Cl. 711/167; 711/158

(57) ABSTRACT

Each of a plurality of memory blocks returns data in different latency in reply to a data request from a request source. The closer a request destination memory block is to the request source, in the shorter latency the data is returned.

### CROSS-REFERENCE TO RELATED APPLICATION

This is a continuation of an International Application No. PCT/JP02/09290, which was filed on Sep. 11, 2002.

### BACKGROUND OF THE INVENTION

1. Field of the Invention

The present invention relates to a data processing device with memory composed of a plurality of blocks, and a method thereof for processing such memory data.

2. Description of the Related Art

Improvement in both the degree of integration and speed of large-scale integrated circuits (LSI), including micro-processors is remarkable. With the high speed of an LSI, its difference with external memory, such as a main storage and like has increased. In order to fill in up the difference, a method for mounting a cache memory with a large capacity (that is, a large area) on an LSI has become popular.

In small devices requiring data processing capability, including a cellular phone and a personal digital assistance (PDA), a processor and a main storage device are encapsulated in an LSI. It can be easily predicted that with the improvement of the degree of integration, the memory capacity of an LSI will go on increasing.

In the conventional memory control, all accesses to large-capacity memory mounted on an LSI are made by single latency (for example, see Patent References 1 and 2).
Patent Reference 1: Japanese Patent Application Publication No. 09-045075
Patent Reference 2: Japanese Patent Application Publication No. 2000-298983

In this case, latency means time from when a data request is issued until requested data returns, and as the unit of latency, the number of cycles of a clock used for the synchronization of a circuit is used.

If single latency is used, no difference in latency occurs between an access to memory physically located remotely from a request source and an access to memory close to the request source. Main reasons for such control are as follows.
(1) In single latency, control is simple.
(2) Conventionally, a ratio of wiring delay time to the entire delay time in an LSI is small, and delay is mainly caused by gate delay time. Therefore, even if wiring delay time somewhat increases due to the position of memory disposed in an LSI, it can be included in one cycle. Therefore, even between two segments of memory each with a somewhat different delay time, the same latency can be easily used.

However, as with the advancement of the processing technology of semiconductors, the speed (clock frequency) of an LSI has further improved, the wiring delay time in an LSI has become dominant, and delay difference due to a difference in a position disposed in an LSI between the two segments of memory cannot be negligible. If in such a state, control is performed by single latency as ever, as a result, a wiring delay time obtained when the farthest memory is accessed cannot be helped being adopted. In that case, the latency of memory access becomes very long to affect process performance.

FIG. 1 shows a hypothetical configuration in which memory control by single latency is applied to large-capacity memory mounted on an LSI. The LSI shown in FIG. 1 is composed of a request source 11 and memory 12. The memory 12 is composed of four memory blocks M1, M2, M3 and M4. M1, M2, M3 and M4 are disposed close to the request source 11 in that order.

Each memory block comprises flip-flop circuits (FF) 21 and 22, random-access memory (RAM) 23 for storing data, and a selector 24.

Each of the FF 21 and 22 functions as a buffer circuit with one stage (one cycle). The selector 24 selects either an output path from the RAM 23 in the same block or an output path from another farther block, and outputs data from the selected path.

In this case, if the distance between the request source 11 and each block is converted into latency, the distance is expressed by the total number of FFs 21 included in both a path for transferring a data request issued from the request source 11 to the RAM 23 of the issuance destination and a path for transferring data outputted from the RAM 23 to the request source 11. In this example, the distances up to the blocks M1, M2, M3 and M4 are two, four, six and eight cycles, respectively.

If there is no difference in latency between blocks, the number of the farthest block M4 is adopted, and FFs 22 are added to the other blocks in such a way that the number of FFs of each block may become equal to the number of M4. Accordingly, the average latency becomes as follows.
Average latency=Maximum latency=8 cycles

Therefore, the process of a request to memory blocks other than M4 greatly delays.

### SUMMARY OF THE INVENTION

It is an object of the present invention to provide a data processing device for improving memory access speed when large-capacity memory is mounted on a semiconductor integrated circuit, such as an LSI, and a method thereof.

The first data processing device of the present invention comprises a plurality of memory blocks, a plurality of transfer paths, and a selector.

Each of the plurality of memory blocks has different latency for each data request issued from the request source 11. Each memory block receives the data request and outputs requested data. Each of the plurality of transfer paths transfers data from these memory blocks to the request source. Then, the selector selects a transfer path from the issuance destination memory block of the data request to the request source, from the plurality of transfer paths.

The second data processing device of the present invention comprises a plurality of cache memory blocks, a control circuit, a plurality of tag transfer paths, a plurality of data transfer paths, a first selector and a second selector.

Each of the plurality of cache memory blocks includes a tag memory for receiving a data request issued from a request source and outputting the tag of the requested data, and a data memory for receiving the data request and outputting the requested data, has different data latency for a data request. The control circuit performs cache control using an outputted tag.

Each of the plurality of tag transfer paths transfers a tag from each cache memory block to the control circuit. Each of the plurality of data transfer paths transfers data from each cache memory block to the request source.

The first selector selects a tag transfer path from the issuance destination cache memory of the data request to the request source, from these tag transfer paths. The second selector selects a data transfer path from the issuance destination cache memory block of the data request to the request source, from these data transfer paths.

### BRIEF DESCRIPTION OF THE DRAWINGS

FIG. 1 shows the configuration of a hypothetical LSI with a plurality of memory blocks;

FIG. 2 shows the classification of the data processing device of the present invention;

FIG. 3 shows the first basic configuration;

FIG. 4 shows the second basic configuration;

FIG. 5 shows the conflict of data outputs between two requests;

FIG. 6 shows a first example of delaying request issuance;

FIG. 7 shows a second example of delaying request issuance;

FIG. 8 shows a first application configuration;

FIG. 9 shows an example of delaying data output;

FIG. 10 shows a second application configuration;

FIG. 11 shows the configuration of a first variable-length buffer;

FIG. 12 shows the configuration of a second variable-length buffer;

FIG. 13 shows the configuration of a third variable-length buffer;

FIG. 14 shows the configuration of an access input control circuit;

FIG. 15 shows the details of the second application configuration;

FIG. 16 shows the configuration of a variable-length buffer stage number selection circuit;

FIG. 17 shows the configuration of a data valid flag response circuit;

FIG. 18 shows a basic cache memory configuration;

FIG. 19 shows a third example of delaying request issuance;

FIG. 20 shows a first cache memory application configuration;

FIG. 21 shows an example of delaying both tag output and data output;

FIG. 22 shows a second cache memory application configuration; and

FIG. 23 shows the configuration of a chip-level multi-processor.

### DESCRIPTION OF THE PREFERRED EMBODIMENTS

The preferred embodiments of the present invention are described in detail below with reference to the drawings.

In this preferred embodiment, memory in an LSI is divided into a plurality of blocks according to a latency difference so that a result can be returned to an access to a block with short latency (block located physically close to a request source). Thus, average latency is shortened by effectively using a latency difference, and accordingly, the performance of an LSI can be improved.

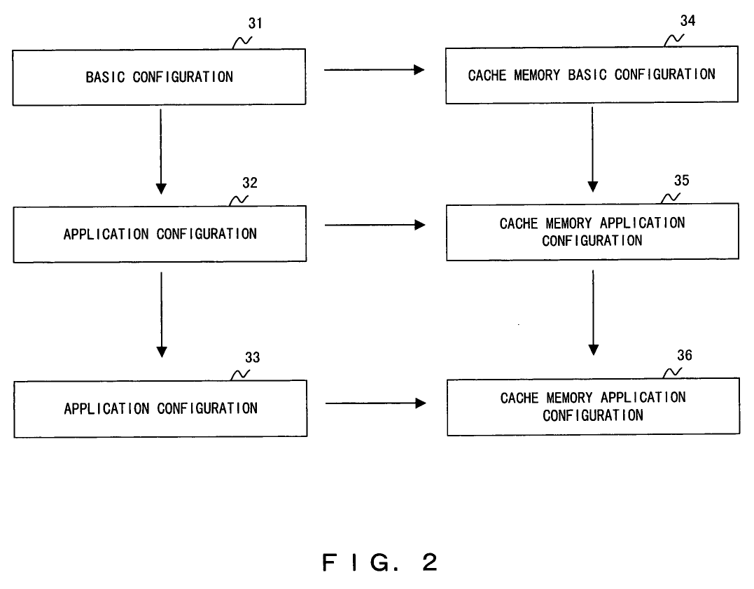

The configuration of the data processing device in this preferred embodiment can be largely classified into six configurations as shown in FIG. 2. A basic configuration 31 takes into consideration the relationship between the position of a request source and the position of data disposed in memory, and the data in the memory is divided into blocks according to a latency difference. An application configuration 32 can be obtained by adding one step of a variable-length buffer to the block with the shortest latency of the basic configuration 31.

An application configuration 33 can be obtained by adding a variable-length buffers to not only the block with the shortest latency, but also blocks with longer latency of the basic configuration 31. In this case, a variable-length buffer with plural stages capable of realizing the same latency as the longest latency, to each block.

Then, configurations 34, 35 and 36 indicate preferred embodiments whose configurations 31, 32 and 33, respectively, are also extended and applied to a cache memory.

In the cache memory basic configuration 34, data and tags in cache memory are divided into blocks according to a latency difference. A cache memory application configuration 35 can be obtained by adding a variable-length buffer with one stage to the block with the shortest latency of the cache memory basic configuration. A cache memory application configuration 36 can be obtained by adding a variable-length buffer with plural stages to each block.

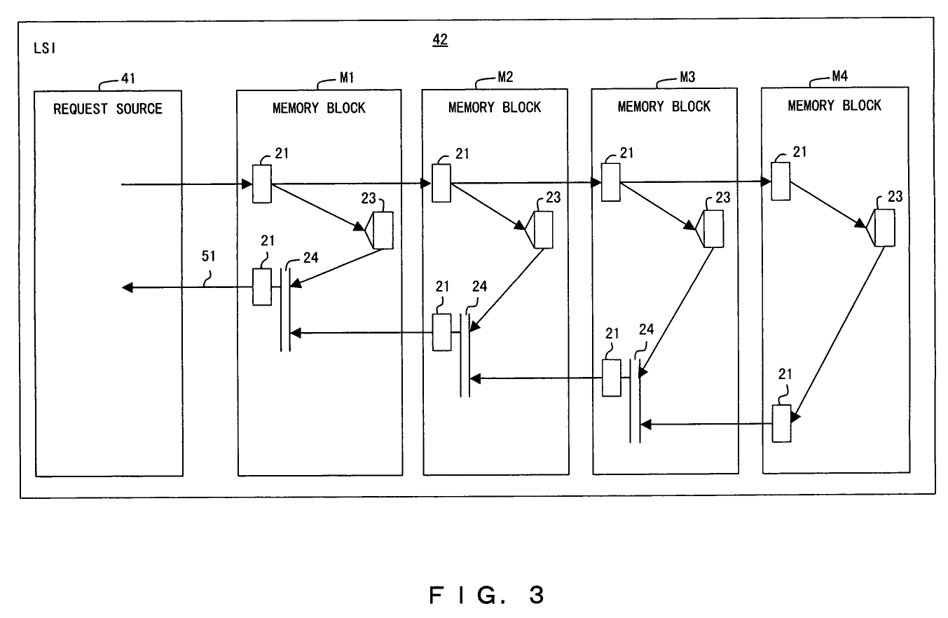

The specific example of each configuration is described below with reference to FIGS. 3 through 23.

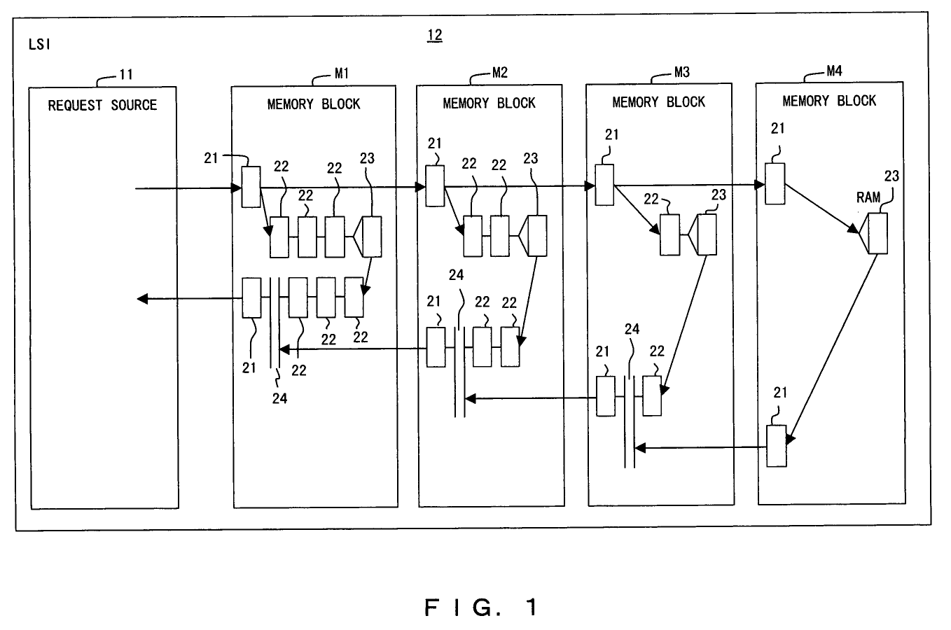

If the basic configuration 31 of the present invention is applied to the LSI shown in FIG. 1, the configuration of an LSI becomes as shown in FIG. 3. The LSI shown in FIG. 3 comprises a request source 41 and memory 42. The memory 42 is divided into four memory blocks M1, M2, M3 and M4.

The request source 41 corresponds to, for example, a main pipeline, an arithmetic unit and the like in a central processing unit (CPU). The request source 41 issues a data request to each block of the memory 42, and receives data from the memory 42 via an output bus 51. In this case, since memory control is performed using latency different for each block, there is no need for FFs 22.

Since the latency of blocks M1, M2, M3 and M4 is two cycles, four cycles, six cycles and eight cycles, respectively, the average latency of memory access becomes as follows.
Average latency=(2+4+6+8)/4=5 cycles

Therefore, performance has improved by three cycles, compared with the case shown in FIG. 1. In the configuration shown in FIG. 3, each memory block comprises a selector 24, which selects either data outputted from the RAM 23 in the same block or data outputted from another block located farther. However, such selection of output data can also be collectively made immediately before the output bus 51.

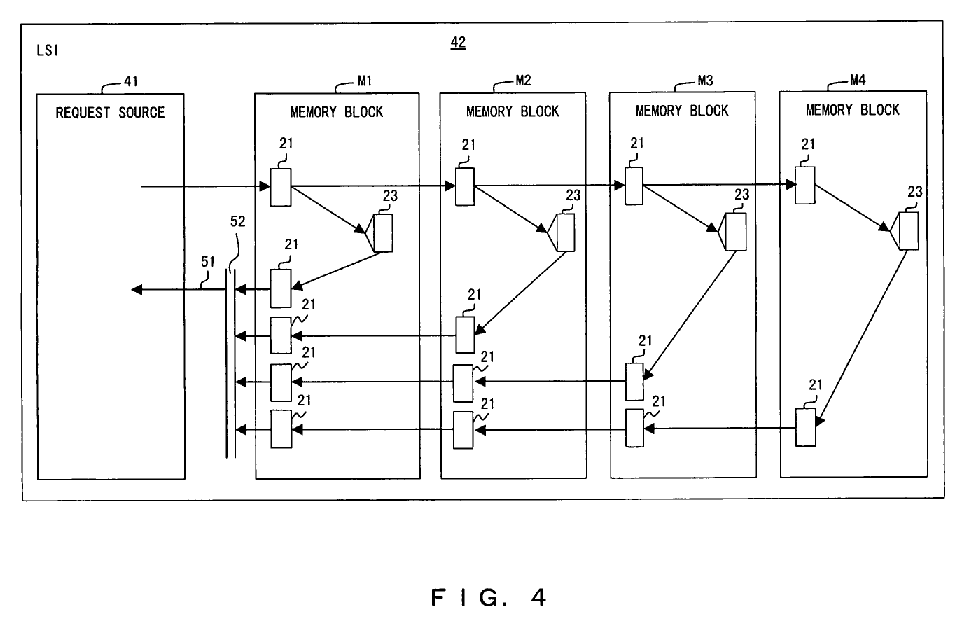

FIG. 4 shows such a configuration of an LSI. To memory blocks M1, M2 and M3 shown in FIG. 4, an FF 22 for transferring data outputted from a block with longer latency is added instead of the selector 24. A selector 52 is provided outside the four memory blocks, selects one of four data transfer paths from those blocks and outputs the data of the selected path to the output bus 51. In reality, a corresponding transfer path is selected according to block identification information included in a data request.

In this case too, the latency of blocks M1, M2, M3 and M4 are two, four, six and eight cycles, respectively, and their average latency becomes five cycles.

However, when data from a block with different latency is returned to the request source, attention must be paid to conflict in the output bus 51 due to a latency difference.

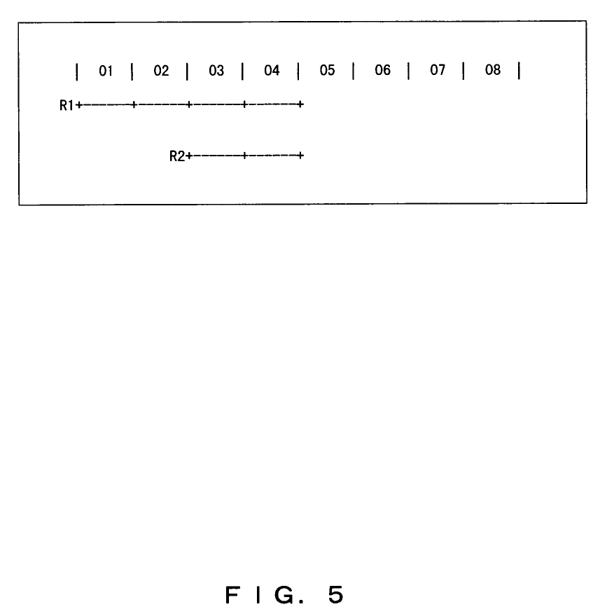

For example, as shown in FIG. 5, it is assumed that two cycles later after a request R1 is issued to block M2 whose latency is four cycles, a request R2 is issued to block M1 whose latency is two cycles. If requests R1 and R2 are issued in cycles 01 and 03, respectively, data for those requests are both outputted to the output bus 51 in cycle 04. Thus, there is conflict in the output bus 51.

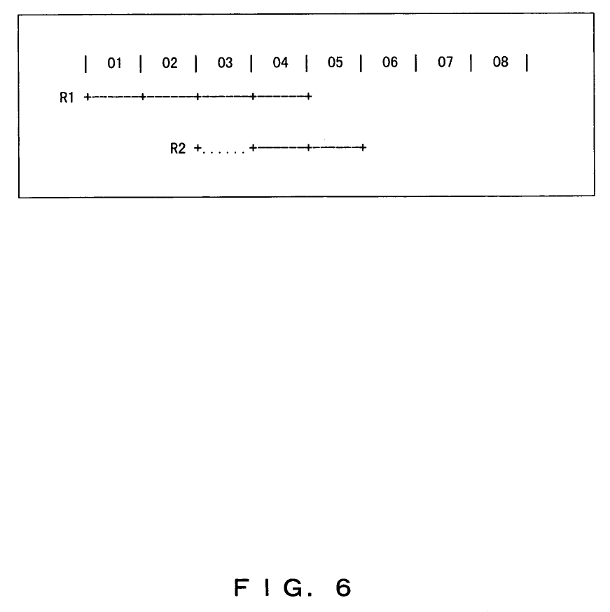

The simplest solution for suppressing this conflict is a method for delaying the issuance of the subsequent request R2 by one cycle as shown in FIG. 6. In this case, since data for request R2 is outputted to the output bus 51 in a cycle 05 instead of cycle 04, there is no conflict.

In order to realize such memory control, the following mechanism (circuit) is added to an LSI.

(a) Since latency is not fixed, an instruction mechanism for instructing a request source to transfer data asynchronously is needed. This instruction mechanism calculates the latency of each request according to an accessing block and notifies the request source that data in the output bus 51 is valid, according to the result.

(b) If there are consecutive requests to a plurality of blocks each with different latency, the conflict of data outputs in the output bus 51 must be avoided. For this purpose, in addition to the instruction mechanism mentioned above in (a) for calculating the latency of each request, a suppression mechanism for storing a request being currently executed in advance and suppressing (delaying) the issuance of a subsequent request if it is determined that there is output conflict, is needed.

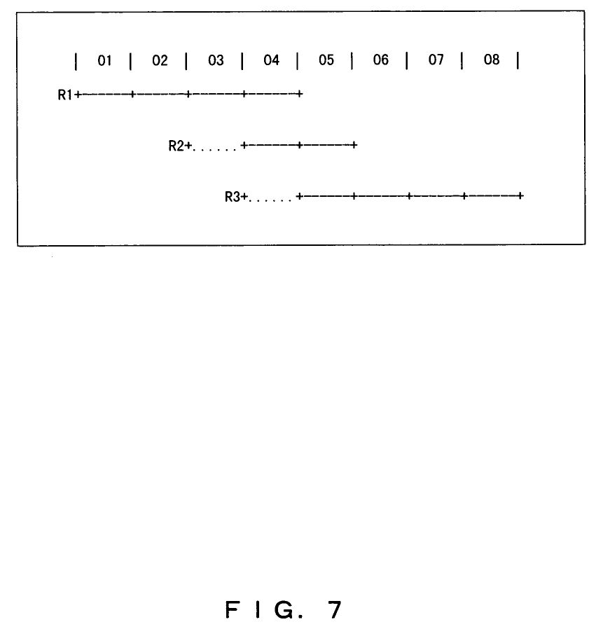

The specific examples of these instruction mechanism and suppression mechanism are described later. In FIG. 6, for example, if a request R3 to block M2 continues immediately after request R2, scheduling shown in FIG. 7 is performed by the suppression mechanism.

In this case, since the latency of the issuance destination of request R3 is four cycles, data is outputted from memory 42 in a cycle 07, if request R3 is issued in a cycle 04, and there is no conflict with request R2. Nevertheless, since the issuance of request R2 delays, the issuance of the subsequent request R3 also delays, and actually data is outputted in a cycle 08. As a result, substantial latency is also affected and prolonged, and the entire throughput degrades.

Thus, it can be considered that data outputs from a plurality of blocks each with different latency is adjusted by adopting the application configuration 32 instead of the basic configuration 31 shown in FIG. 2. In this case, the following functions are added.

(c) A variable-length buffer with one stage is added to the output of a memory block with the shortest latency.

(d) For an access to the memory block with the shortest latency, the following two kinds of determination are simultaneously performed by extending the function of the suppression mechanism mentioned above in (b).
Determination on the conflict situation in the case where a buffer with one stage is not used
Determination on the conflict situation in the case where a buffer with one stage is used

If there is no output conflict when no buffer is used, a transfer path is selected without using a buffer. However, if there is conflict when no buffer is used and there is no conflict when a buffer is used, a transfer path is selected using a buffer. If there is output conflict regardless of the existence/non-existence of a buffer, the issuance of a request is delayed.

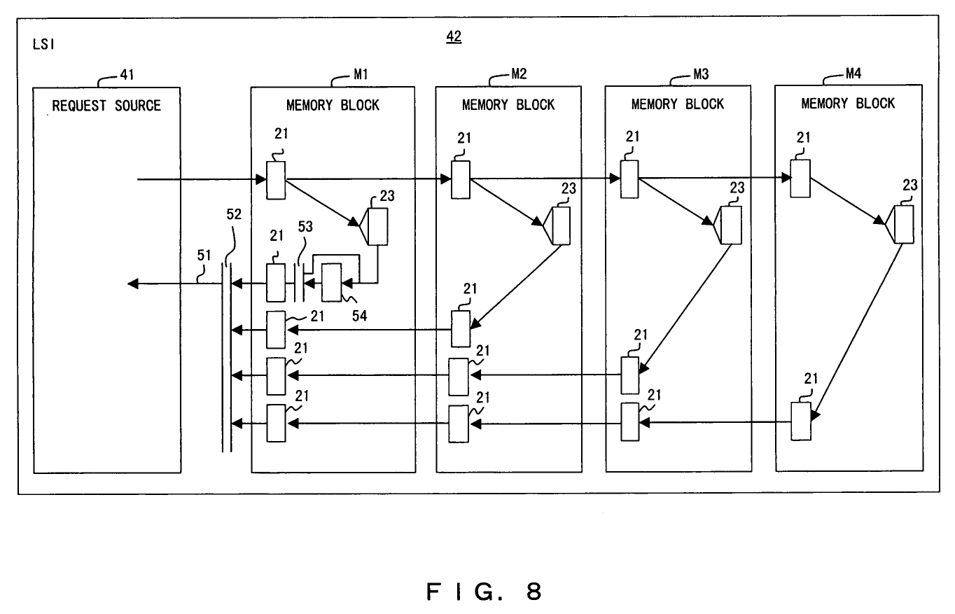

For example, if a variable-length buffer is added to block M1 with the shortest latency (two cycles) in FIG. 4, the configuration of an LSI becomes as shown in FIG. 8. The block M1 shown in FIG. 8 comprises a variable-length buffer with one stage composed of a selector 53 and an FF 54. The selector 53 selects either a path for transferring data directly from the RAM 23 or a path for transferring via the FF 54, based on the conflict situation in which the FF 54 is used as a buffer and the conflict situation in which FF 54 is not used.

If the path via the FF 54 is selected, data output from block M1 can be delayed by one cycle. Therefore, the latency of block M1 becomes variable in the range of 2 through 3 cycles.

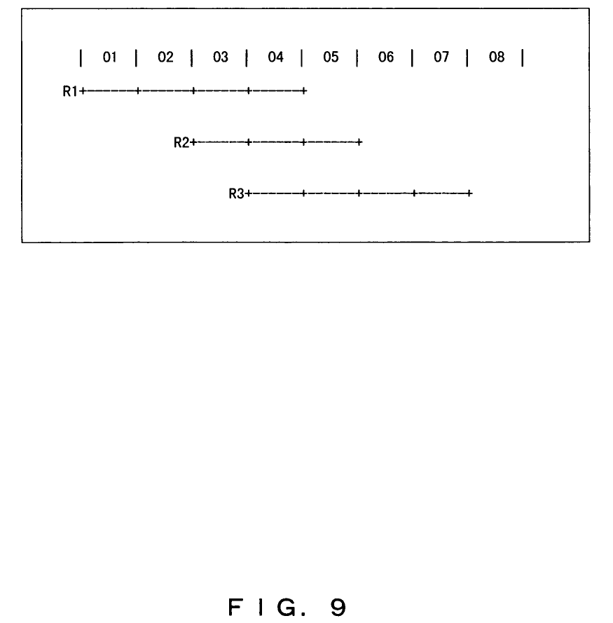

Thus, the issuance of requests R2 and R3 and the latency of data shown in FIG. 7 can be improved as shown in FIG. 9. In this case, if a path via the FF 54 is selected as a transfer path, data output can be delayed by one cycle even when request R2 is issued in a cycle 03. Therefore, there is no conflict with data output for request R1 issued in a cycle 04. Therefore, there is no need to delay the issuance of the subsequent request R3. Thus, request R3 is issued in a cycle 04, and data is outputted in a cycle 07.

The above-mentioned application configuration 32 is a limited countermeasure in which a variable-length buffer is added to only a memory block with the shortest latency in order to minimize the increase of devices. If the increase of devices is allowed, any situation can be coped with by further extending this configuration and preparing a variable-length buffer capable of fitting in up the difference with the longest latency, for all blocks except a memory block with the longest latency. The application configuration 33 shown in FIG. 2 is such a configuration.

In the application configuration 33, a variable-length buffer such that can prolong the latency of each memory block up to the same level as the longest latency, is added to each memory block. Thus, the adjustment range of latency can be expanded and performance degradation due to output conflict can be completely prevented.

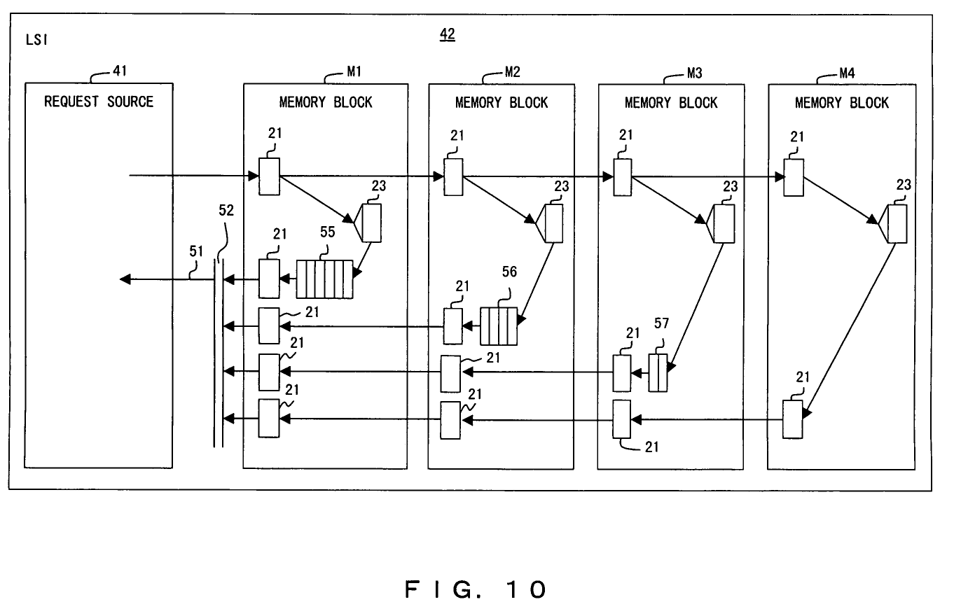

For example, if such a variable-length buffer is added to each of blocks M1 through M3 in FIG. 4, the configuration of an LSI becomes as shown in FIG. 10. The blocks M1, M2 and M3 shown in FIG. 10 comprises variable-length buffers 55, 56 and 57, respectively.

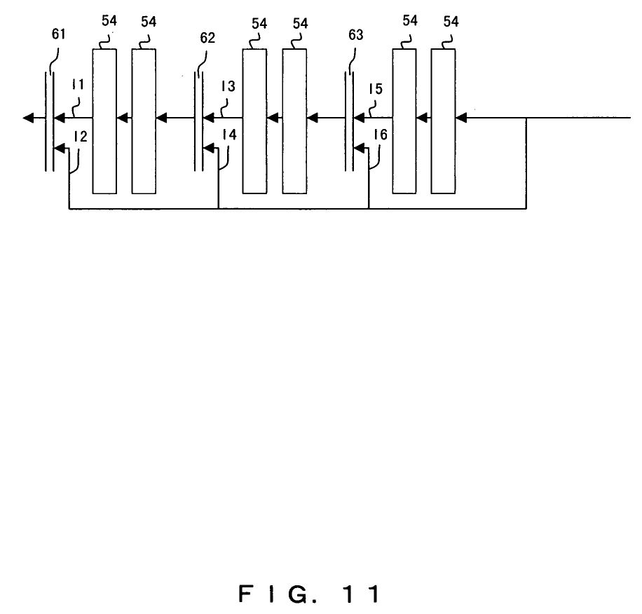

As shown in FIG. 11, the variable-length buffer 55 comprises selectors 61, 62 and 63 and six FFs 54. Each FF 54 is used as a buffer with one stage, and each selector selects either a path for transferring data directly from the RAM 23 or a path for transferring data via the FF 54.

This variable-length buffer can set four buffer lengths of zero stages, two stages, four stages and six stages. These buffer lengths can delay data output by zero cycles, two cycles, four cycles and six cycles, respectively. In the case of zero stages, the selector 61 selects input I2, and in the case of two stages, the selectors 61 and 62 select inputs I1 and I4, respectively. In the case of four stages, the selectors 61, 62 and 63 select inputs I1, I3 and I6, respectively, and in the case of six stages, the selectors 61, 62 and 63 select inputs I1, I3 and I5, respectively.

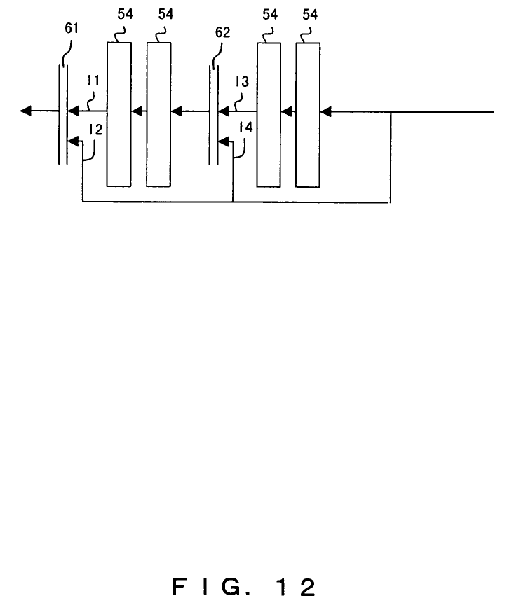

As shown in FIG. 12, the variable-length buffer 56 comprises selectors 61 and 62, and four FFs 54. This variable-length buffer 56 can set three buffer lengths of zero, two and four stages. In the case of zero stages, the selector 61 selects input I2, and in the case of two stages, the selectors 61 and 62 select inputs I1 and I4, respectively. In the case of four stages, the selectors 61 and 62 select inputs I1 and I3, respectively.

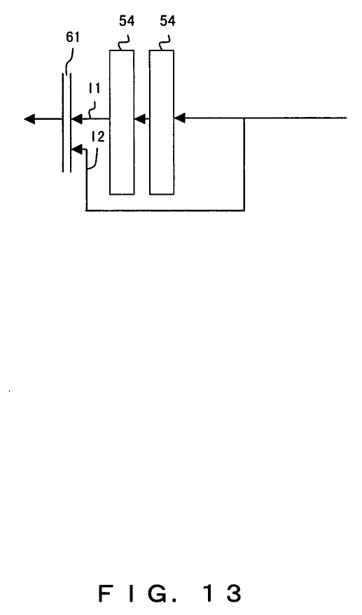

As shown in FIG. 13, the variable-length buffer 57 comprises selectors 61 and 62, and two FFs 54. This variable-length buffer 57 can set two buffer lengths of zero and two stages. In the case of zero stages, the selector 61 selects input I2, and in the case of two stages, the selector 61 selects input I1.

By providing these variable-length buffers, the latency of blocks M1, M2 and M3 become variable in the range of two through eight cycles, four through eight cycles and six through eight cycles, respectively, and any block can realize eight cycles, which is the latency of block M4. Since the longest latency of the memory 42 is eight cycles, in any situation, there is no output conflict if data output is delayed at most by eight cycles.

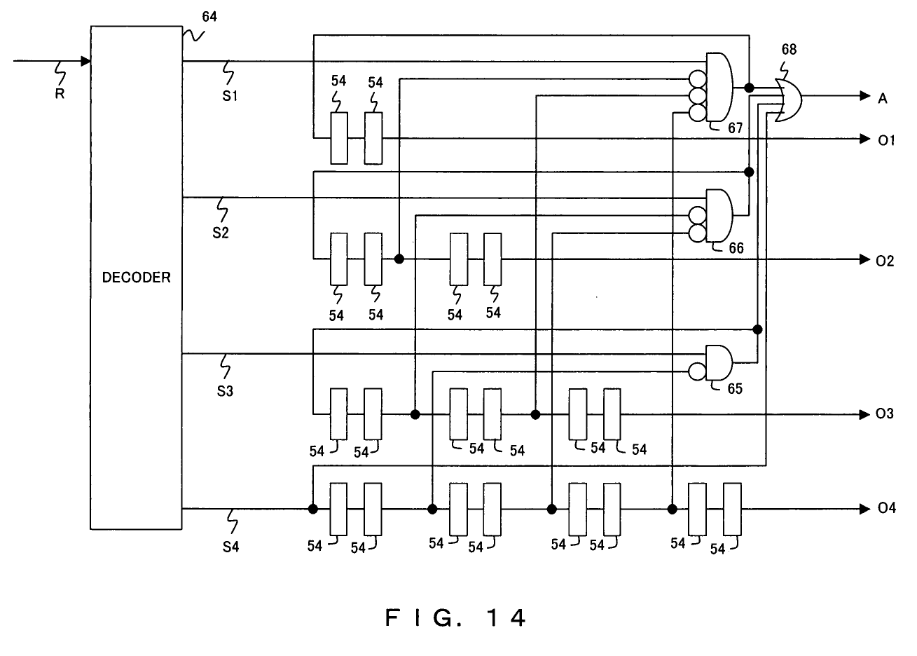

FIG. 14 shows the configuration of an access input control circuit corresponding to one example of the above-mentioned suppression mechanism. The access input control circuit shown in FIG. 14 is provided between the request source 41 and the memory 42. The access input control circuit receives a request signal R from the request source 41 and returns an access signal A to the request source 41.

The access signal A indicates that an access to the memory 42 can be performed in the case of logic “1”, and that the access cannot be performed in the case of logic “0”. The request source 41 delays the issuance of a request until the access signal A becomes logic “1”.

Block output selection signals O1 through O4 are used as the control signals of a selector 52. The selector 52 selects a transfer path from a block M1 when a signal Oi (i=1, 2, 3 and 4) becomes logic “1”.

A decoder 64 obtains the address of an issuance destination by decoding the request signal R, and outputs block selection signals S1 through S4. A signal Si (i=1, 2, 3 and 4) becomes logic “1” if the issuance destination is block Mi.

Signal S4 is inputted to a circuit in which eight FFs 54 are connected in series, and is outputted as signal O4 after eight cycles. The output of an AND circuit 65 becomes logic “1” if signal S3 is logic “1” and signal O4 is logic “0” after six cycles. The output of the AND circuit 65 is inputted to a circuit in which six FFs 54 are connected in series, and is outputted as signal O3 after six cycles.

The output of an AND circuit 66 becomes logic “1” if signal S2 is logic “1” and signals O3 and O4 both are logic “0” after four cycles. The output of the AND circuit 66 is inputted to a circuit in which four FFs 54 are connected in series, and is outputted as signal O2 after four cycles.

The output of an AND circuit 67 becomes logic “1” if signal S1 is logic “1” and signals O2, O3 and O4 all are logic “0” after two cycles. The output of the AND circuit 67 is inputted to a circuit in which two FFs 54 are connected in series, and is outputted as signal O1 after two cycles. Then, an OR circuit 68 outputs the logical sum of signal S4 and the outputs of the AND circuits 65 through 67 as an access signal A.

According to such an access input control circuit, a request whose issuance destination is block M4 is inputted to the memory without any processes. However, as to a request whose issuance destination other blocks than M4, it is checked whether there is data output conflict with a preceding request. If there is the conflict, the issuance of a request is suppressed.

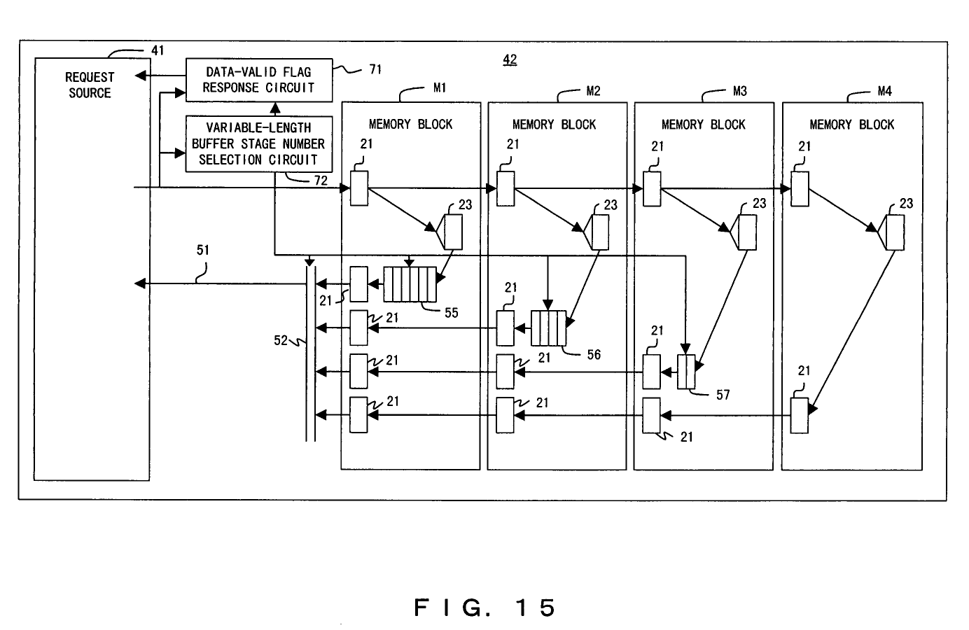

FIG. 15 shows the detailed application configuration of the LSI shown in FIG. 10. In FIG. 15, a data-valid flag response circuit 71 and a variable-length buffer stage number selection circuit 72 are added to the configuration shown in FIG. 10. The variable-length buffer stage number selection circuit 72 stores output buffer reservation information indicating the timing of data output for an issued request and performs control as follows.

(1) The block identification information of an access destination is obtained from the address of a request. For the block identification information, for example, a block number is used. If its block is known, its latency which is at least necessary is known. It is assumed that the latency is n cycles. 0 is set as the initial value of the number m of stages in use of a variable-length buffer.

(2) Whether the output bus 51 is vacant after (n+m) cycles is checked from the output buffer reservation information. If the output bus 51 is not vacant, the process described below in (3) is performed. If the output bus 51 is vacant, the process described below in (4) is performed.

(3) 2 is added to m and the process mentioned above in (2) is performed.

(4) The number of stages of a variable-length buffer of an access destination block is set to m, and data is accessed. The fact that data is outputted after (n+m) cycles is added to the output buffer reservation information and a subsequent request is awaited. Simultaneously, the obtained (n+m) cycle value is notified to the data-valid flag response circuit 71.

The data-valid flag response circuit 71 corresponds to an example of the above-mentioned instruction mechanism, and transfers a data-valid flag to the request source 41 after (n+m) cycles. Thus, the fact that data in the output bus 51 is valid after (n+m) cycles is notified to the request source 41.

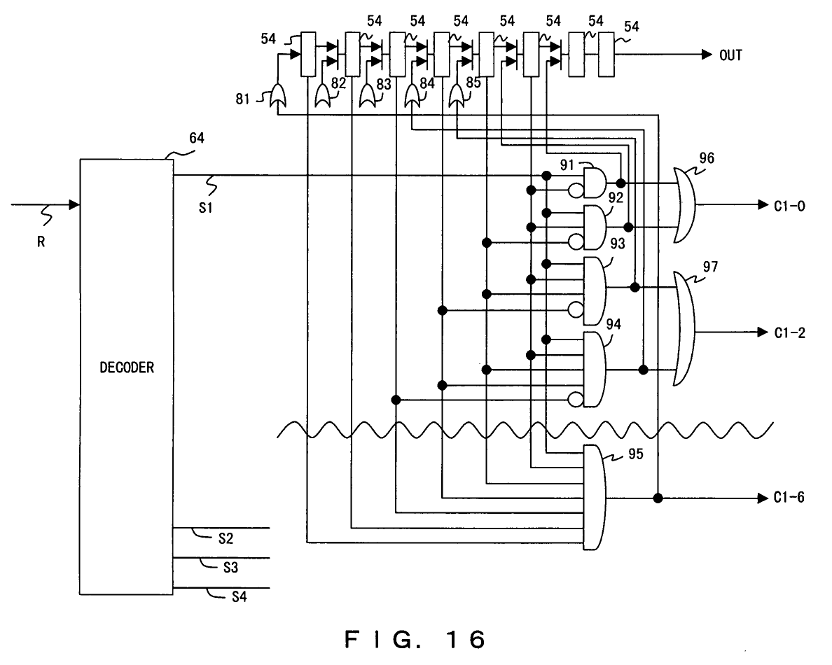

FIG. 16 shows one configuration of a variable-length buffer stage number selection circuit 72. In FIG. 16, the decoder 64, request signal R and block selection signals S1 through S4 are the same as those in FIG. 14.

A circuit in which eight FFs 54 are connected in series forms a preceding request display bit map and stores the output buffer reservation information. A timing signal OUT outputted from the FF 54 at the final stage becomes logic “1” in a cycle in which data is outputted.

Buffer stage number selection signals C1-0 through C1-6 are used as the control signals of the variable-length buffer 55 of block M1. When signal C1-i (i=0, 2, 4 and 6) is logic “1”, i-stages of buffer length is set in the variable-length buffer 55. However, in FIG. 16, signal C1-4 is omitted.

Although, in FIG. 16, only a circuit for generating the buffer stage number selection signal of block M1 is shown, the buffer stage number selection signals of the other blocks are also generated by the same circuit. The buffer stage number selection signal C2-i (i=0, 2 and 4) of the variable-length buffer 56 of block M2 is generated from signal S2, and the buffer stage number selection signal C3-i (i=0 and 2) of the variable-length buffer 57 of block M3 is generated from signal S3.

The output of an AND circuit 91 becomes logic “1” if the following two conditions are met.
Signal S1 is logic “1”.
Signal OUT is logic “0” after two cycles.

The output of the AND circuit 91 is inputted to the second last FF 54, and is outputted as signal OUT after two cycles.

The output of an AND circuit 92 becomes logic “1” if the following three conditions are met.
Signal S1 is logic “1”.
Signal OUT is logic “1” after two cycles.
Signal OUT is logic “0” after three cycles.

The output of the AND circuit 92 is inputted to the third last FF 54, and is outputted as signal OUT after three cycles. An OR circuit 96 outputs the logical sum of the respective outputs of the AND circuits 91 and 92 as a buffer stage number selection signal C1-0.

According to such a circuit, if the output bus 51 is vacant after two cycles, the buffer length of the variable-length buffer 55 is set to zero stages. If the output bus 51 is vacant after three cycles even when the output bus 51 is not vacant after two cycles, the buffer length of the variable-length buffer 55 is set to zero stages. In this case, if the output of requested data is delayed by one cycle, there is no output conflict.

The output of an AND circuit 93 becomes logic “1” if the following four conditions are met.
Signal S1 is logic “1”.
Signal OUT is logic “1” after two cycles.
Signal OUT is logic “1” after three cycles.
Signal OUT is logic “0” after four cycles.

An OR circuit 85 outputs the logical sum of the output of the AND circuit 93 and the outputs of the AND circuits, which are not shown, of the other blocks. The output of the OR circuit 85 is inputted to the fourth last FF 54, and is outputted as signal OUT after four cycles.

The output of an AND circuit 94 becomes logic “1” if the following five conditions are met.
Signal S1 is logic “1”.
Signal OUT is logic “1” after two cycles.
Signal OUT is logic “1” after three cycles.
Signal OUT is logic “1” after four cycles.
Signal OUT is logic “0” after five cycles.

An OR circuit 84 outputs the logical sum of the output of the AND circuit 94 and the outputs of the AND circuits, which are not shown, of the other blocks. The output of the OR circuit 84 is inputted to the fifth last FF 54, and is outputted as signal OUT after five cycles.

An OR circuit 97 outputs the logical sum of the respective outputs of the AND circuits 93 and 94 as a buffer stage number selection signal C1-2.

According to such a circuit, if the output bus 51 is vacant after four cycles, the buffer length of the variable-length buffer 55 is set to two stages. If the output bus 51 is vacant after five cycles even when the output bus 51 is not vacant after four cycles, the buffer length of the variable-length buffer 55 is set to two stages. In this case, if the output of requested data is delayed by one cycle, there is no output conflict.

The output of an AND circuit 95 becomes logic “1” if the following seven conditions are met.
Signal S is logic “1”.
Signal OUT is logic “1” after two cycles.
Signal OUT is logic “1” after three cycles.
Signal OUT is logic “1” after four cycles.
Signal OUT is logic “1” after five cycles.
Signal OUT is logic “1” after six cycles.
Signal OUT is logic “1” after seven cycles.

An OR circuit 81 outputs the logical sum of the output of the AND circuits 95 and the outputs of the AND circuits for the other blocks, which are not shown in FIG. 16. The output of the OR circuit 81 is inputted to the first FF 54, and is outputted as signal OUT after eight cycles. The output of the AND circuit 95 is used as a buffer stage number selection signal C1-6.

According to such a circuit, if the output bus 51 is not vacant after two through seven cycles, the buffer length of the variable-length buffer 55 is set to six stages. In this case, since the latency becomes the longest eight cycles, there is no output conflict.

Similarly, OR circuits 82 and 83 outputs the logical sum of the respective outputs of the AND circuits which are not shown in FIG. 16. The output of the OR circuit 83 is inputted to the sixth last FF 54, and is outputted as signal OUT after six cycles. The output of the OR circuit 82 is inputted to the seventh last FF 54, and is outputted as signal OUT after seven cycles. A buffer stage number selection signal C1-4 is generated in the same way as the other selection signals.

According to such a variable-length buffer stage number selection circuit 72, an optimal buffer length can be selected, according to the block number of an issuance destination and the data output timing of a preceding request. Therefore, the conflict of data outputs can be prevented while utilizing a latency difference between blocks.

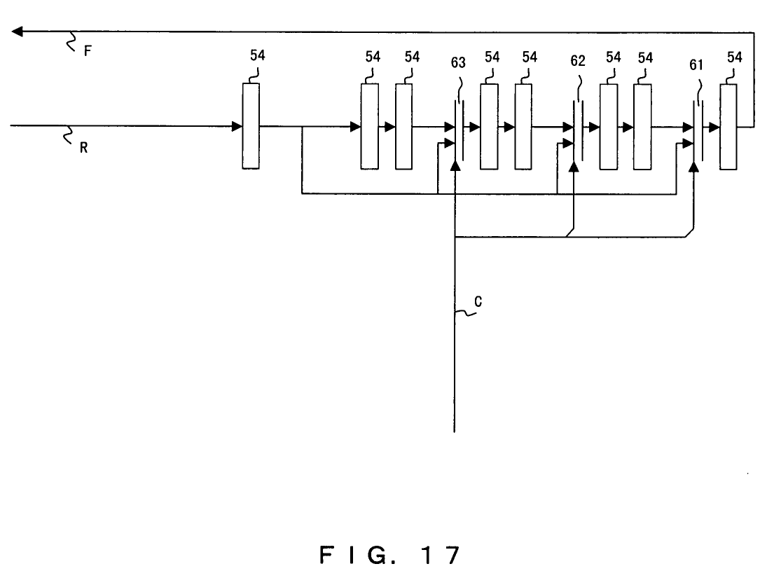

FIG. 17 shows the configuration of a control circuit for memory block M1, of the data valid flag response circuit 71. The control circuit shown in FIG. 17 has a configuration obtained by adding the FF 54 to each of the input and output sides of the variable-length buffer shown in FIG. 11. The control circuit shifts a request signal R from the input side to the output side one after another and outputs the request signal R as a data-valid flag F. In the case of the memory block M1, since n=2, m=0, 2, 4 and 6, n+m=2, 4, 6 and 8.

The selectors 61, 62 and 63 are controlled by a selection signal C (corresponding to signals C1-0 through C1-6) from the variable-length buffer stage number selection circuit 72 in the same way as in the variable-length buffer shown in FIG. 11. Therefore, a data-valid flag F can be transferred to the request source 41 in a timing data is outputted from the memory block M1. The configuration of a control circuit for each of the other memory blocks is the same as the circuit shown in FIG. 17.

The timing signal OUT shown in FIG. 16 can also be used instead of the data-valid flag F generated by the data-valid flag response circuit 71. In this case, since signal OUT is transferred to the request source 41, there is no need for the data-valid flag response circuit 71.

In the configuration shown in FIG. 15, a variable-length buffer is provided for all memory blocks other than memory block M4 with the longest latency in order to cope with any situation. However, if it is sufficient to be able to cope with only a limited situation, a variable-length buffer can be provided for only a part of memory blocks.

The configuration shown in FIG. 8 can be regarded as the simplification of the configuration shown in FIG. 15. Therefore, memory blocks can be controlled by the same control circuit composed of the data-valid flag response circuit 71 and the variable-length buffer stage number selection circuit 72. In this case, the configuration of such a control circuit can be easily predicted from FIGS. 16 and 17.

The above-mentioned basic configuration 31 and application configurations 32 and 33 are used for general memory. In the case of a cache memory, not only data but also a tag can have the same latency difference. A cache memory basic configuration 34 and cache memory application configurations 35 and 36 can be obtained by extending and applying the basic configuration 31 and application configurations 32 and 33, respectively, shown in FIG. 2 to a cache memory.

When applying the present invention to a cache memory in an LSI, the structure of a tag must be taken into consideration. If the amount of tags is small compared with data and the tags of all blocks can be disposed near the request source, the tags can be handled by the basic configuration 31 and application configurations 32 and 33. However, if the amount of tags is not negligibly small, the tags must be distributed and disposed. Therefore, the cache memory basic configuration 34 is applied to and used for a large capacity of cache memory by the addition of the following components/functions.

(e) Data is distributed and disposed for each cache line. Thus, both tags can also be distributed and disposed for each block.

(f) The suppression mechanism mentioned above in (b) is extended. If there is the conflict to the output bus of data outputs or there is the conflict of outputs from a tag, the issuance of a request is suppressed.

In cache memory, the validity of data, such as the hit/miss of a cache line and the like is determined using the output of a tag. If the suppression mechanism mentioned above in (f) is not provided, control logic for determining/processing tag output for each block is needed. For example, there is a possibility that a plurality of requests requiring an external access is caused by a cache miss. In such a case, new control and a new circuit for arbitrating those requests are needed. Therefore, control becomes easier if the suppression mechanism mentioned above in (f) is adopted.

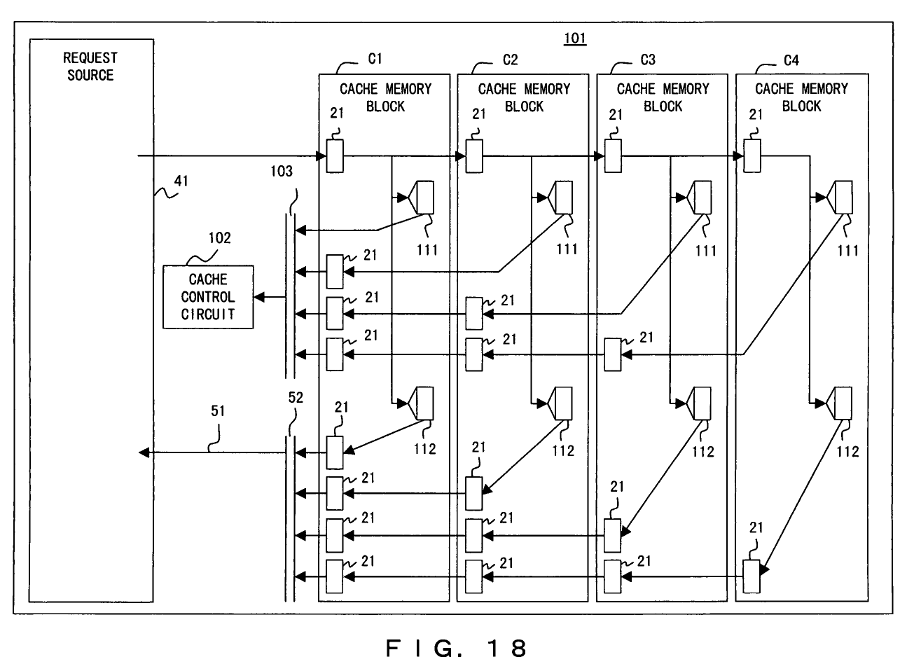

FIG. 18 shows one configuration of an LSI provided with such a cache memory. The LSI shown in FIG. 18 comprises the request source 41 and a cache memory 101. The cache memory 101 is divided into four cache memory blocks, C1, C2, C3 and C4.

Each cache memory block comprises an FF 21, tag RAM 111 and data RAM 112, and outputs tags and data, according to a request from the request source 41.

A selector 103 selects one of tag transfer paths from four blocks, and outputs the tag of the selected path to a cache control circuit 102. Upon receipt of the tag, the cache control circuit 102 performs the hit/miss determination of the tag, and controls the operation of the cache memory 101, according to the result of the determination. A selector 52 selects one of tag transfer paths from four blocks, and outputs the data of the selected path to the output bus 51.

Such a configuration in which the tag section and data section of cache are integrated has the following implementation advantages.

(1) Repeatability

Another cache memory block can be easily generated by duplicating one cache memory block.

(2) Localization of Delay Analysis

If delay analysis is applied to one cache memory block, the result of the analysis can be applied to another cache memory block.

In the configuration shown in FIG. 18, the respective latency of data and a tag are as follows.
Block C1: Data latency=2, tag latency=1
Block C2: Data latency=4, tag latency=3
Block C3: Data latency=6, tag latency=5
Block C4: Data latency=8, tag latency=7

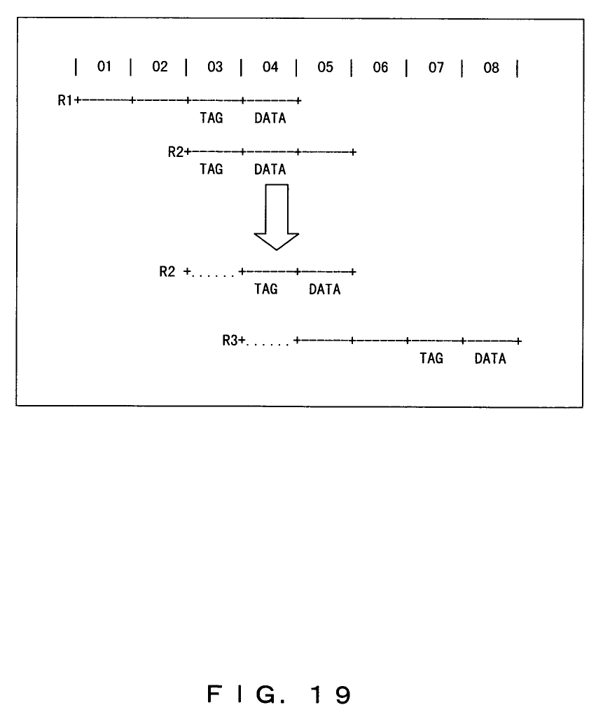

Here it is assumed as in FIG. 7 that two cycles later after request R1 is issued to block C2, request R2 is issued to block C1, and immediately after request R3 is issued to block C2. In this case, as shown in FIG. 19, when requests R1 and R2 are issued in cycles 01 and 03, respectively, there is the conflict of tag outputs for those requests in cycle 03. Therefore, the suppression mechanism delays the issuance of request R2 by one cycle. Due to this, the issuance of request R3 also delays by one cycle.

In order to prevent such performance degradation, the cache memory application configuration 35 is used. In this configuration, a variable-length buffer with one stage as in FIG. 8 is added to both tag output and data output from a block with the shortest latency. Thus, freedom in request issuance increases in a cache memory in which tags are distributed and disposed, and the activation of a subsequent request can be advanced by one cycle. Accordingly, average latency is shortened, and more effective scheduling can be realized.

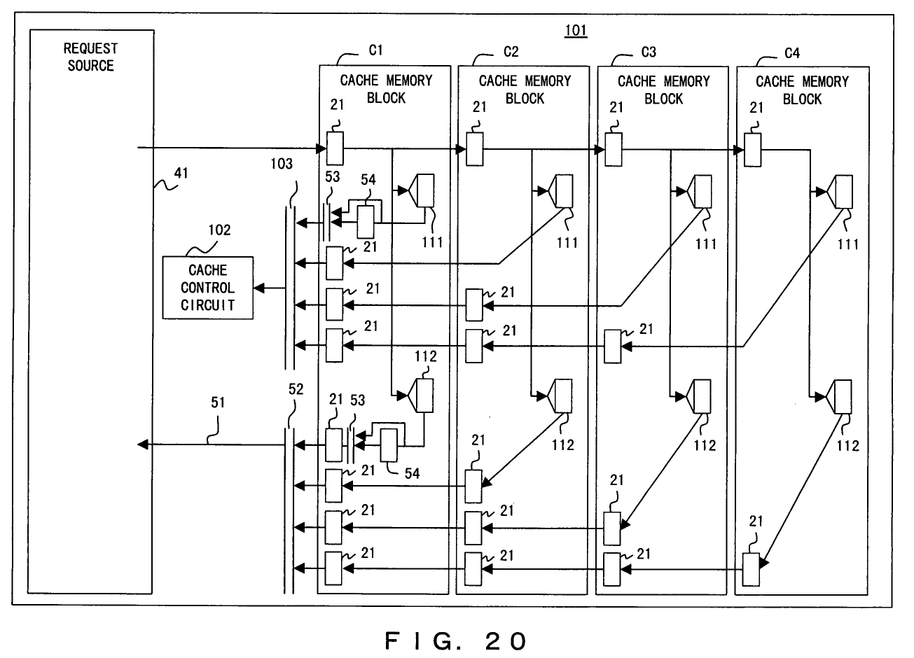

If a variable-length buffer as in FIG. 8 is added to the tag RAM 111 and data RAM 112 of the cache memory block C1 shown in FIG. 18, the configuration of an LSI becomes as shown in FIG. 20.

In a variable-length buffer on the output side of the tag RAM 111, the selector 53 selects either a path for transferring data directly from the tag RAM 111 or a path transferring data via the FF 54. In a variable-length buffer on the output side of the data RAM 112, the selector 53 selects either a path for transferring data directly from the tag RAM 111 or a path transferring data via the FF 54.

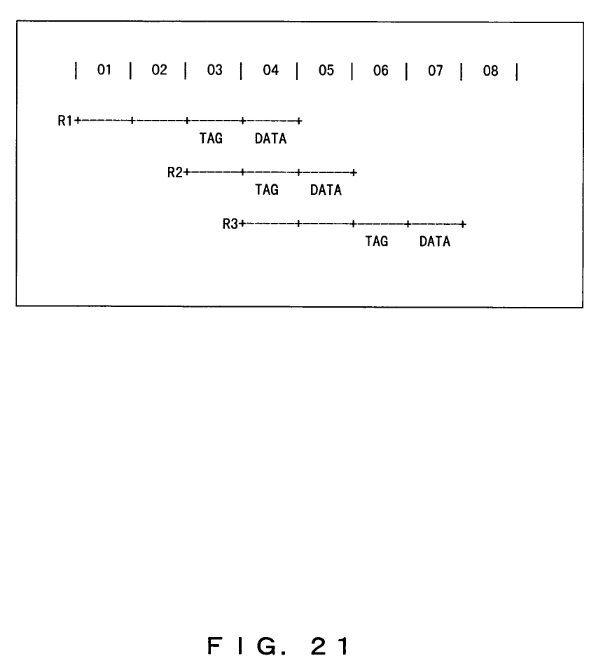

According to such a configuration, scheduling shown in FIG. 21 becomes possible for three requests shown in FIG. 19. In this case, if a path via the FF 54 is selected as a tag transfer path even when request R2 is issued in cycle 03, tag output can be delayed by one cycle. Therefore, there is no conflict with tag output for request R1 in cycle 03. Therefore, there is no need to delay the issuance of requests R2 and R3.

In the cache memory application configuration 36, a variable-length buffer such that can prolong the latency of each cache memory block up to the longest latency is added to both tag output and data output from each cache memory block. Thus, any situation can be coped with, and the best average latency can be obtained.

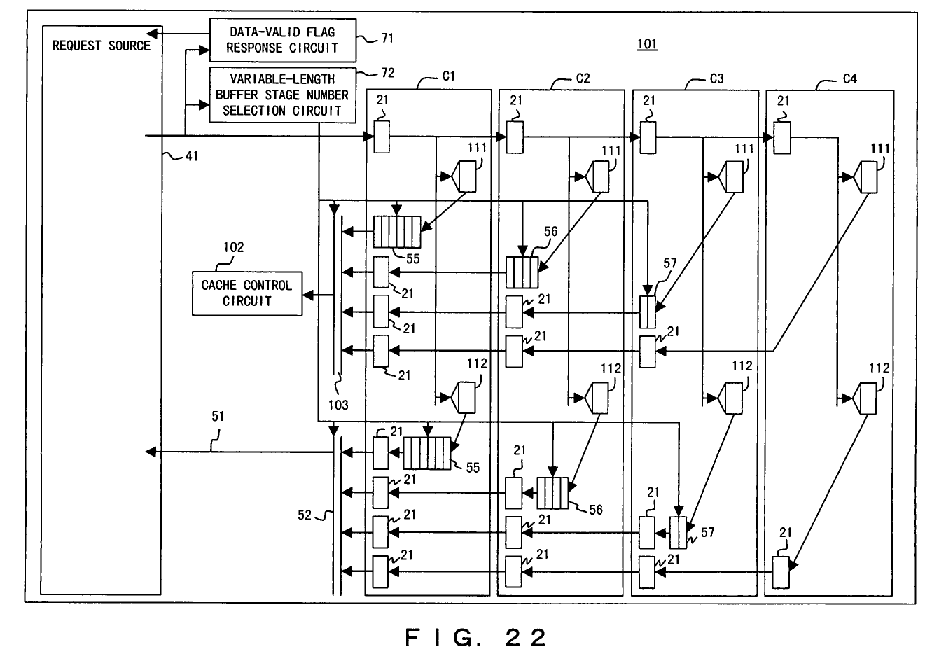

For example, if such a variable-length buffer is added to each tag RAM 111 and data RAM 112 of blocks C1 through C3 in FIG. 18, the configuration of an LSI becomes as shown in FIG. 22.

On each output side of the tag RAM 111 and data RAM 112 of block C1, a variable-length buffer 55 is provided, and on each output side of the tag RAM 111 and data RAM 112 of block C2, a variable-length buffer 56 is provided. On each output side of the tag RAM 111 and data RAM 112 of block C3, a variable-length buffer 57 is provided.

The respective configurations and operations of the variable-length buffers 55, 56 and 57, the data-valid flag response circuit 71 and the variable-length buffer stage number selection circuit 72 are already described above. In this case, two variable-length buffers in each block are controlled by the same selection signal from the variable-length buffer stage number selection circuit 72, and the selectors 103 and 52 are also controlled by the same selection signal.

By providing these variable-length buffers, the tag latency of blocks C1, C2 and C3 become variable in the ranges of one to seven cycles, two to seven cycles and five to seven cycles, respectively, and any block can realize seven cycles, which is the tag latency of block C4. Since the longest tag latency of the cache memory 101 is seven cycles, there will be no conflict of tag output if tag output is delayed at most by seven cycles in any situation. The adjustment range of data latency is the same as in FIG. 15.

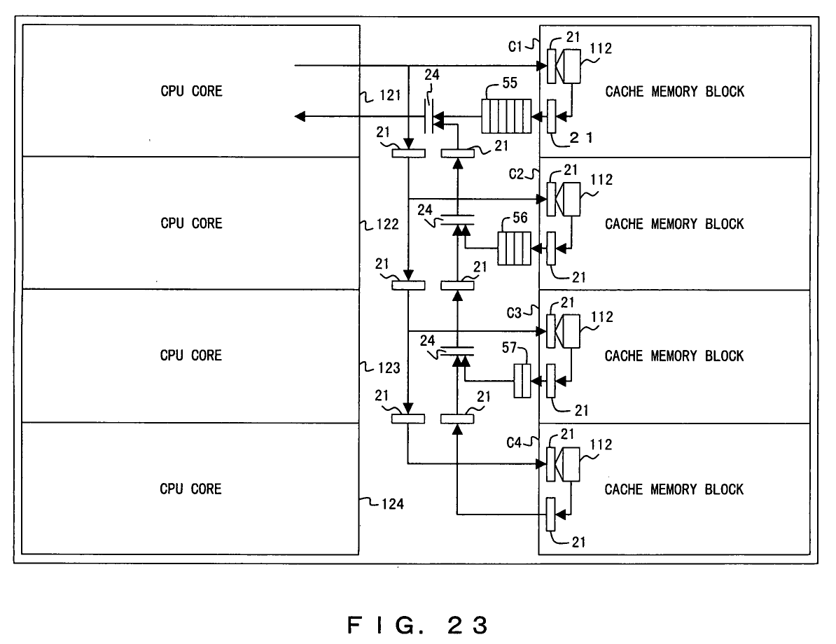

FIG. 23 shows a configuration in the case where the cache memory application configuration is applied to a chip-level multi-processor (CMP). The CMP is a system provided with a plurality of processors (CPU COREs) in an LSI chip, and in the CMP, a multi-processor configuration which is conventionally realized using a plurality of chips can be realized by one chip.

In the configuration shown in FIG. 23, four CPU COREs 121, 122, 123 and 124 are mounted on a chip, and these CPU COREs share a large capacity of on-chip cache. This on-chip cache is composed of four cache memory blocks C1, C2, C3 and C4. The respective functions of the variable-length buffers 55, 56 and 57 are the same as in FIG. 22. Each selector 24 selects either an output path from a nearby variable-length buffer or an output path from a farther block.

In this example, only a path for transferring a request from the CPU CORE 121 to the data RAM 112 of each block and a path for transferring data from each data RAM 112 to the CPU CORE 121 are shown, and the tag RAM and a transfer path accompanying it are omitted. However, each block is also provided with these circuits as in the configuration shown in FIG. 22. Each of the other CPU COREs is provided with the same circuits as the CPU CORE 121.

However, as clear from the physical disposition, block C1 is the closest to the CPU CORE 121, and block C4 is the farthest. Therefore, for the CPU CORE 121, the shortest data latency of blocks C1, C2, C3 and C4 are two, four, six and eight cycles, respectively.

Conversely, block C1 is the farthest from a CPU CORE 124, and block C4 is the nearest. Therefore, for the CPU CORE 124, the shortest data latency of blocks C1, C2, C3 and C4 are eight, six, four and two cycles, respectively.

From a CPU CORE 122, block C2 is the nearest, and blocks C1 and C3 are the second nearest, and block C4 is the farthest. Therefore, the shortest data latency of blocks C1, C2, C3 and C4 are four, two, four and six cycles, respectively.

From a CPU CORE 123, block C3 is the nearest, blocks C2 and C4 are second nearest, and block C1 is the farthest. Therefore, the shortest data latency of blocks C1, C2, C3 and C4 are six, four, two and four cycles, respectively.

According to such a CMP configuration, as to each of a plurality of processors that share memory on a chip, the average latency of memory access can be optimized.

According to the present invention, if a large capacity of memory is mounted on a semiconductor integrated circuit, the speed of memory access can be improved by utilizing a latency difference according to the storage position of data.

1. A data processing device, comprising:
a request source for issuing a data request;
a plurality of memory blocks each of which has different latency for the data request, for receiving the data request and outputting requested data;
a plurality of transfer paths for transferring data from the plurality of memory blocks to the request source; and
a selector for selecting a transfer path from a memory block of an issuance destination of the data request to the request source, from the plurality of transfer paths.

2. The data processing device according to claim 1, wherein
when there is conflict of data output between the data request and another preceding data request, said request source delays timing of issuing the data request.

3. The data processing device according to claim 1, wherein
a transfer path from a memory block with the shortest latency to said request source, of said plurality of transfer paths, includes a variable-length buffer for changing timing of outputting data to a bus provided between said request source and said plurality of transfer paths.

4. The data processing device according to claim 3, wherein
when there is conflict of data output for the bus between the data request and another preceding data request, the timing of outputting the data is delayed.

5. The data processing device according to claim 1, wherein
at least a part of transfer paths of said plurality of transfer paths include a variable-length buffer for changing timing of outputting data to a bus provided between the request source and said plurality of transfer paths.

6. The data processing device according to claim 5, wherein
said variable-length buffer includes a circuit for prolonging latency of a memory block belonging to a transfer path including the relevant variable-length buffer up to the same value as the longest latency.

7. The data processing device according to claim 5, wherein
when there is conflict of data output for the bus between the data request and another preceding data request, said variable-length buffer delays the timing of outputting the data.

8. A data processing device, comprising:
a plurality of memory blocks each of which has different latency for a data request issued by a request source, for receiving the data request and outputting requested data;
a plurality of transfer paths for transferring data from the plurality of memory blocks to the request source; and
a selector for selecting a transfer path from a memory block of an issuance destination of the data request to the request source, from the plurality of transfer paths.

9. A data processing device, comprising:
a request source for issuing a data request;
a plurality of cache memory blocks each of which includes a tag memory for receiving the data request and outputting a tag of requested data and a data memory for receiving the data request and outputting the requested data and has different latency for the data request;
a control circuit for performing cache control using outputted tag;
a plurality of tag transfer paths for transferring tags from the plurality of cache memory blocks to the control circuit;
a plurality of data transfer paths for transferring data from the plurality of cache memory blocks to the request source;
a first selector for selecting a tag transfer path from a cache memory block of an issuance destination of the data request to the control circuit, from the plurality of tag transfer paths; and
a second selector for selecting a data transfer path from the cache memory block of the issuance destination to the request source, from the plurality of data transfer paths.

10. The data processing device according to claim 9, wherein
when there is conflict of tag output for said control circuit between the data request and another preceding data request, said request source delays timing of issuing the data request.

11. The data processing device according to claim 9, wherein
a tag transfer path from a cache memory block with the shortest data latency of said plurality of tag transfer paths includes a first variable-length buffer for changing timing of supplying a tag to said control circuit and
a data transfer path from the cache memory block with the shortest data latency of said plurality of data transfer paths includes a second variable-length buffer for changing timing of outputting data to a bus provided between the request source and said plurality of data transfer paths.

12. The data processing device according to claim 11, wherein
when there is conflict of tag output for said control circuit between the data request and another preceding data request, said first variable-length buffer delays the timing of supplying the tag.

13. The data processing device according to claim 9, wherein
at least a part of tag transfer paths of said plurality of tag transfer paths includes a first variable-length buffer for changing timing of supplying a tag to said control circuit and a data transfer path from a cache memory block belonging to the part of tag transfer paths of said plurality of data transfer paths includes a second variable-length buffer for changing timing of outputting data to a bus provided between the request source and said plurality of data transfer paths.

14. The data processing device according to claim 13, wherein
when each of said plurality of cache memory blocks has different tag latency for the data request, said first variable-length buffer includes a circuit for prolong tag latency of a cache memory block belonging to a tag transfer path including the first variable-length buffer up to the same value as the longest tag latency, and
said second variable-length buffer includes a circuit for prolong data latency of a cache memory block belonging to a data transfer path including said second variable-length buffer up to the same value as the longest data latency.

15. The data processing device according to claim 13, wherein
when there is conflict of tag output for said control circuit between the data request and another preceding data request, said first variable-length buffer delays the timing of supplying the tag.

16. A data processing device, comprising:
a plurality of cache memory blocks each of which includes a tag memory for receiving a data request issued by a request source and outputting a tag of requested data and a data memory for receiving the data request and outputting the requested data and has different latency for the data request;
a control circuit for performing cache control using outputted tag;
a plurality of tag transfer paths for transferring tags from the plurality of cache memory blocks to the control circuit;
a plurality of data transfer paths for transferring data from the plurality of cache memory blocks to the request source;
a first selector for selecting a tag transfer path from a cache memory block of an issuance destination of the data request to the control circuit, from the plurality of tag transfer paths; and
a second selector for selecting a data transfer path from the cache memory block of the issuance destination to the request source, from the plurality of data transfer paths.

17. a data processing method, comprising:
transferring a data request issued by a request source to a memory block of an issuance destination of the data request of a plurality of memory blocks each of which has different latency for the data request;
selecting a transfer path from the memory block of the issuance destination to the request source, from a plurality of transfer paths for transferring data from the plurality of memory block to the request source;
transferring data outputted by the memory block of the issuance destination to the request source, using a selected transfer path.

18. A data processing method, comprising:
transferring a data request issued by a request source to a cache memory block of an issuance destination of a plurality of cache memory blocks each of which includes a tag memory for receiving the data request and outputting a tag of requested data and a data memory for receiving the data request and outputting the requested data, and has different data latency for the data request;
selecting a tag transfer path from the cache memory block of the issuance destination to a control circuit for performing cache control, from a plurality of tag transfer paths for transferring tags from the plurality of cache memory blocks to the control circuit;
selecting a data transfer path from the cache memory block of the issuance destination to the request source of a plurality of data transfer paths for transferring data from the plurality of cache memory blocks to the request source;
transferring a tag outputted from the cache memory block of the issuance destination to the control circuit using a selected tag transfer path; and
transferring data outputted from the cache memory block of the issuance destination to the request source using a selected data transfer path.

19. A data processing device, comprising:
request source means for issuing a data request;
a plurality of memory block means each of which has different latency for the data request, for receiving the data request and outputting requested data;
a plurality of transfer path means for transferring data from the plurality of memory block means to the request source means; and
selector means for selecting a transfer path means from a memory block means of an issuance destination of the data request to the request source means, from the plurality of transfer path means.
